(19) United States
(12) Patent Application Publication
(10) Pub. No.: US 2022/0086187 A1
(43) Pub. Date: Mar. 17, 2022

(54) DECENTRALIZED DIGITAL CONTENT DISTRIBUTION SYSTEM AND PROCESS USING BLOCK CHAINS AND ENCRYPTED PEER-TO-PEER NETWORK

(71) Applicants: Zachary James LeBeau, New York, NY (US); Milad Mostavi, Bucharest (RO)

(72) Inventors: Zachary James LeBeau, New York, NY (US); Milad Mostavi, Bucharest (RO)

(21) Appl. No.: 17/411,455

(22) Filed: Aug. 25, 2021

Related U.S. Application Data
(63) Continuation of application No. PCT/US2020/020563, filed on Mar. 1, 2020.
(60) Provisional application No. 62/812,280, filed on Mar. 1, 2019.

(51) Int. Cl. H04L 29/06; H04L 9/08; H04L 29/08

(52) U.S. Cl. CPC H04L 63/164; H04L 63/045; H04L 63/162; H04L 2209/603; H04L 67/104; H04L 67/06; H04L 2209/38; H04L 9/0819

(57) ABSTRACT

A method and system provide a digital content file over a decentralized distribution system using an encrypted peer-to-peer network by (a) uploading a Layer 1 encrypted content file to a host device of the decentralized distribution system; (b) encrypting the digital content file with Layer 3 encryption using a public key of the host device; (c) exchanging a first temporary symmetric key between a seeder device of the decentralized distribution system and a peer device of the decentralized distribution system; (d) encrypting the digital content file with Layer 2 encryption using the first temporary symmetric key; (e) transmitting the Layer 2 encrypted digital content file to the peer device of the decentralized distribution system; (f) encrypting the digital content file with Layer 3 encryption using a public key of the peer device; (g) exchanging a second temporary symmetric key between the peer device of the decentralized distribution system and a consumer device outside the decentralized distribution system; (h) encrypting the digital content file with Layer 2 encryption using the second temporary symmetric key; and (i) transmitting the Layer 2 encrypted digital content file to the consumer device.

### PRIORITY INFORMATION

The present application is a continuation application of PCT Patent Application Number PCT/US2020/020563, filed on Mar. 1, 2020, and claims priority, under 35 U.S.C. § 120, from PCT Patent Application Number PCT/US2020/020563, filed on Mar. 1, 2020. The entire content of PCT Patent Application Number PCT/US2020/020563, filed on Mar. 1, 2020, is hereby incorporated by reference.

PCT Patent Application Number PCT/US2020/020563, filed on Mar. 1, 2020, claims priority, under 35 U.S.C. § 119(e), U.S. Provisional Patent Application, Ser. No. 62/812,280, filed on Mar. 1, 2019. The entire content of U.S. Provisional Patent Application, Ser. No. 62/812,280, filed on Mar. 1, 2019, is hereby incorporated by reference.

This application claims priority from U.S. Provisional Patent Application, Ser. No. 62/812,280, filed on Mar. 1, 2019.

### COPYRIGHT NOTICE

A portion of the disclosure of this patent application/document contains material (program code and/or pseudocode) which is subject to copyright protection. The copyright owner(s) has/have no objection to the facsimile reproduction by anyone of the patent document or patent disclosure, as it appears in the Patent and Trademark Office patent file or records, but otherwise, the copyright owner(s) reserve(s) all copyright rights.

### BACKGROUND

Digital media has opened many avenues for creativity and expression; however, digital media presents issues with respect to securing of profit from the distribution (sale) of the digital media (creative work) or the exercising of control over the distribution of digital media (creative work).

Early forms of distribution of digital media included files written to electronic media, such as floppy disks, CDs and DVDs. These early forms of distribution of digital media presented issues in that the distribution relied upon a tangible static medium to physically contain the digital media so as to convey the digital media.

To overcome the reliance on a tangible static medium, digital media began to be distributed as electronic files over the Internet or other communication systems.

For example, digital files containing music (digital media) could be conveyed to a customer, over the internet, after the purchase thereof from a website, such as iTunes™. A copy of the digital file containing the desired music would be transmitted from the website to the customer's personal computing device, such as a laptop, computer, tablet, personal digital assistant, smart phone, electronic audio player, etc. Thereafter, the customer would be able to listen to the music.

Although allowing a copy of the digital file (digital media) to be transmitted to a customer overcomes the reliance on a tangible static medium, it presents other problems such as piracy, wherein piracy is the copying or distribution of electronic digital media without paying the fees required by the publishers and/or distributors.

For example, the ability to copy files reduces costs so low that theft and illicit distribution are virtually free and leave little, if any evidence of the theft.

One solution to this piracy problem has been to equip files with electronic digital rights management systems to restrict the uses of the digital media.

Digital rights management systems have proven to be unpopular with end users because of all the restrictions or constraints, making sharing or even backing up the files difficult or impossible. The complaints of the end users have caused some producers of digital media to use the absence of digital rights restrictions on the digital media as a selling point.

On the other hand, another solution to the piracy problem has driven a great deal of creative content to reside in centralized platforms such as iTunes™, Netflix™ and Amazon Kindle™.

These centralized platforms further centralize control over the digital media (creative work) into the hands of publishers, producers, and distributors rather than the artists (creators of the digital media) and reduces the “profits” realized by the artists.

Artists (creators) do not favor the centralization and control of their material because the artists have not necessarily benefitted from such controls, despite the breadth and immediacy of streaming options for distribution.

More specifically, when an artist turns over control of their work to another entity, who has access to marketing and distribution channels, it is this non-artist entity who reap the lion's share of the benefit, not the creator of the digital media.

To address the centralized control issue, the distribution connections or channels should be effectively controlled by the artist or digital media creator. As with the conventional digital distribution channels, the Internet provides a communication platform to enable a system that places the necessary distribution connections or channels in the effective control of the artist or digital media creator. However, a communication platform is not enough to address specific distribution issues, security issues, etc.

FIG. 1 illustrates a conventional system managing the distribution of digital media content. As illustrated in FIG. 1, a computing environment manages media. The computing environment includes a content management system 110, which provides an application programming interface service 115 to access various different media management functions provided by the content management system 110.

The online host media site 140 contains a JavaScript™ module 145 that facilitate communicating over the network 125 to access and retrieve certain information associated with the uploaded content, such as rights information, ownership information, licensing or purchasing information, unique identifiers, provenance information, and so on. The content management system 110 stores such information in various databases or memory.

The database 120 includes content information 122 associated with digital content items, such as information describing the digital content items, information representing the content items, metadata associated with the digital content items, and so on. The database 120 also include contract data or information 124 associated with rights assigned to the digital content items and/or use of the digital content items, and one or more public ledgers 126, such as block chains associated with the digital content items that track transactions performed with respect to the digital content items.

The content management system 110 includes various components that perform digital currency transactions in order to establish the transfer of rights of digital content between entities and various components that generate, create, update, or otherwise maintain public ledgers of the performed transactions.

For example, the content management system 110 includes a content registration module, a transaction module, a public ledger module, and a contract module.

The content registration module is configured and/or programmed to register digital content items received from owners of the digital content items.

The transaction module is configured and/or programmed to perform bitcoin or other digital currency transactions to generate public ledger entries that represent rights transfers of the digital content items between providers and recipients.

The public ledger module is configured and/or programmed to maintain a public ledger of the generated public ledger entries for the registered digital content items.

The contract module is configured and/or programmed to maintain contracts for registered digital content items.

The content management system manages the rights to registered digital content with the public ledger module, which generates a block chain of transaction entries for digital content, wherein each of the transaction entries represents a transfer of a right to digital content from a provider of the digital content to a recipient of the digital content, and the transaction module, which performs transactions to transfers rights of the digital content from providers to recipients, wherein the performed transactions include transfers of digital currency between bitcoin (or other digital currency) addresses associated with the providers of the digital content and bitcoin (or other digital currency) addresses associated with the recipients of the rights to the digit content.

It is noted that a bitcoin is a distributed crypto-currency or a decentralized digital currency. Bitcoin uses cryptography to control the creation and transfer of money; enables instant payments to anyone, anywhere in the world; and uses peer-to-peer technology to operate with no central authority.

Bitcoin is an open source software application and a shared protocol, which allows users to pseudo-anonymously and instantaneously transact, using a digital currency, without needing to trust counterparties or separate intermediaries by utilizing public/private key pairs, a popular encryption technique.

A cryptographically secure decentralized peer-to-peer electronic payment system enables transactions involving virtual currency in the form of digital tokens, which are a type of crypto-currency whose implementation relies on cryptography to generate the digital tokens as well as validate related transactions.

The cryptographically secure decentralized peer-to-peer electronic payment system prevents counterfeiting and double-spending problems without any centralized authority by using a public digital ledger accessible to all network nodes in which all cryptographically secure decentralized peer-to-peer electronic payment system's balances and transactions are announced, agreed upon, and recorded. The transactions are time-stamped by hashing the transaction into an ongoing chain of hashed digital signatures based upon asymmetric or public key cryptography forming a record that cannot be changed without redoing the entire chain.

Other examples of conventional system managing the distribution of digital media content using block chain technology are described in Published US Patent Application Number 2016/0321675; Published US Patent Application Number 2016/0321676; Published US Patent Application Number 2016/0321769; and Published US Patent Application Number 2016/0323109.

The entire contents of Published US Patent Application Number 2016/0321675; Published US Patent Application Number 2016/0321676; Published US Patent Application Number 2016/0321769; and Published US Patent Application Number 2016/0323109 are hereby incorporated by reference.

Other examples of system for managing the distribution of digital media content are described in U.S. Pat. Nos. 7,895,349; 9,608,829; Published US Patent Application Number 2005/0138081; Published US Patent Application Number 2010/0138508; Published US Patent Application Number 2015/0026072; Published US Patent Application Number 2015/0332283; Published US Patent Application Number 2016/0085955; Published US Patent Application Number 2017/0091756; Published US Patent Application Number 2017/0103468; and Published US Patent Application Number 2017/0109748.

The entire contents of U.S. Pat. Nos. 7,895,349; 9,608,829; Published US Patent Application Number 2005/0138081; Published US Patent Application Number 2010/0138508; Published US Patent Application Number 2015/0026072; Published US Patent Application Number 2015/0332283; Published US Patent Application Number 2016/0085955; Published US Patent Application Number 2017/0091756; Published US Patent Application Number 2017/0103468; and Published US Patent Application Number 2017/0109748 are hereby incorporated by reference.

Notwithstanding the various conventional examples described above, these conventional processes and systems fail to adequately provide the artist or creator of the digital media a system that effectively puts control of the distribution of the digital media in the control of the artist/creator as well as provide an effective distribution system that maximizes exposure of the digital media to entities that are interested in acquiring or utilizing the digital media.

Therefore, it is desirable to provide a system which provides an efficient and effective distribution platform to maximize exposure of the digital media to entities that are interested in acquiring or utilizing the digital media.

Moreover, it is desirable to provide a system which provides an efficient and effective distribution platform that is decentralized and is effectively controlled by the artist/creator of the digital media.

In addition, it is desirable to provide a system which provides an efficient and effective distribution platform that does not require a specialized set of skills to utilize.

It is further desirable to provide a system which provides an efficient and effective decentralized distribution platform that maximizes exposure of the digital media to entities that are interested in acquiring or utilizing the digital media while being effectively controlled by the artist/creator (content owners) of the digital media and having an interface that is easy to use and highly efficient.

Published PCT Patent Application WO 2018/213672 discloses a system which provides an efficient and effective distribution platform to maximize exposure of the digital media to entities that are interested in acquiring or utilizing the digital media. The entire content of Published PCT Patent Application WO 2018/213672 is hereby incorporated by reference.

Although Published PCT Patent Application WO 2018/213672 discloses a system which provides an efficient and effective distribution platform to maximize exposure of the digital media to entities that are interested in acquiring or utilizing the digital media, such a system needs to provide the proper safeguards (encryption and/or authentication) to protect the intellectual property rights of the content owners.

Therefore, it is desirable to provide a system and/or platform that provides the proper safeguards (encryption and/or authentication) to protect the intellectual property rights of the content owners.

Moreover, it is desirable to provide a system and/or platform that provides the proper safeguards (encryption and/or authentication) to protect the intellectual property rights of the content owners by providing individually (independently) applied encryption to full or partial files throughout the network with a private key not even known to the user.

### BRIEF DESCRIPTION OF THE DRAWINGS

The drawings are only for purposes of illustrating various embodiments and are not to be construed as limiting, wherein:

FIG. 1 is a block diagram illustrating a conventional computing environment for performing transactions associated with digital content;

FIG. 2 illustrates a block diagram of a decentralized distribution system for digital media;

FIG. 3 is an overview of the general architecture of a platform for the decentralized distribution system for digital media of FIG. 2;

FIG. 4 is a block diagram illustrating a process for authenticating a wallet holder in the decentralized distribution system for digital media;

FIG. 5 is a block diagram illustrating a process for creating a project in the decentralized distribution system for digital media;

FIG. 6 is a block diagram illustrating a process for launching a created token on the decentralized distribution system for digital media;

FIG. 7 is a flowchart illustrating a process for funding a created token on the decentralized distribution system for digital media;

FIG. 8 is a block diagram illustrating a process for content distribution on the decentralized distribution system for digital media;

FIG. 9 illustrates a network based system (network based platform) that individually applies encryption to full or partial files throughout the network; and

FIGS. 10 and 11 illustrate a flowchart showing an encryption scheme for transferring content from a content owner to a purchasing device over a peer-to-peer network.

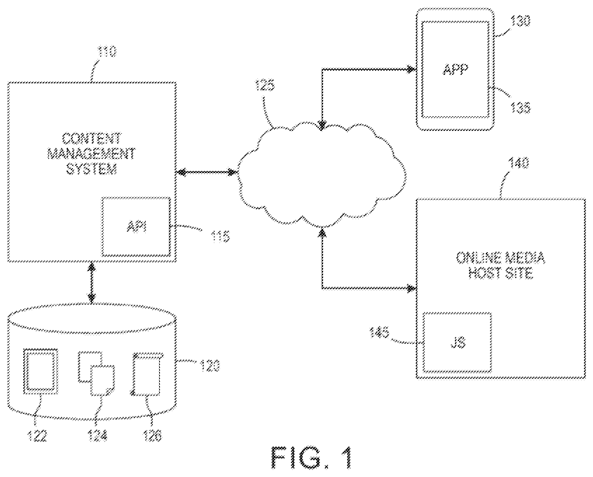

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

The use and distribution of digital content, such as digital documents, images, multimedia, and so on, has historically been difficult to track, control and/or protect by owners of the digital content, especially online.

For example, social networks, messaging, micro-blogs, and so on, provide easy mechanisms for users to view, share, and appropriate content provided by others. Content creators and owners, therefore, often face problems when attempting to assert the ownership of their works and, in some cases, license or receive remuneration for the use of their works by others.

A system and method for managing media, such as digital content, using block chain technology are described below. The system and method provide block chain-based attribution and authentication to creators of media and other digital content.

For example, the system and method may provide decentralized distribution channels for digital content, such as social media networks and other networks; smart contract execution environments for regulating usage and payments of fees and royalties for use of digital content; and block chain based media usage metering, rights transactions, and payment services.

The decentralized distribution system for digital media, described below, is a multi-layered system that allows flexibility in funding, monetizing, and distributing digital media, such as entertainment products (movies, TV shows, e-books, e-literature, digitalized photos, digitalized artwork, music, etc.) or any intellectual property that can be digitized.

In one embodiment, decentralized distribution system for digital media generally has four modules or subsystems, each of which is a distinct system onto itself.

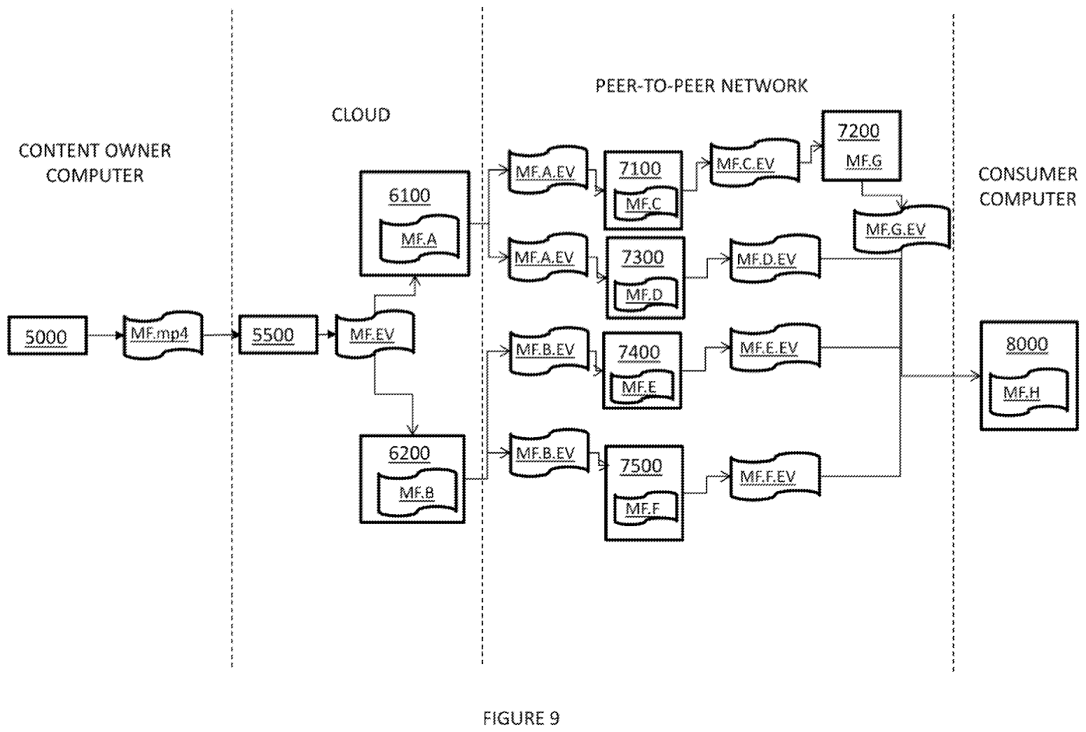

The first module or subsystem of the decentralized distribution system for digital media is the front end or user interface, wherein an example of such an interface is illustrated by FIG. 9 through FIG. 26 and described below. The front end or user interface may be a web-based system that allows users (artist/creators) to create projects and manage their rights, revenue, royalties, and rewards.

The front end or user interface may also be a more distributed system, similar to a cryptocurrency wallet.

The second module or subsystem of the decentralized distribution system for digital media is a token system. The tokens or cryptotokens used in the decentralized distribution system for digital media are roughly equivalent to a cryptocurrency such as Bitcoin or Ether but with specific utility programmed therein.

In the decentralized distribution system for digital media, the tokens are unique to the project for which the tokens are created rather than being a general use currency because the tokens are programmed with a specific set of functions and utility.

When a project issues tokens to the general public, the tokens can be acquired in exchange for Ether or other form of cryptocurrency, wherein the tokens signify participation in the project and in any possible rewards associated therewith.

The third module or subsystem of the decentralized distribution system for digital media is a smart contract system, wherein smart contracts are generated, updated, and managed. The smart contracts are ordered together to administer a range of functions and in doing so are called smart contract systems.

The decisions users make and communicate through the front-end or user interface about distribution terms including pricing, rights, revenue, royalty allocation, and fund-raising are all reflected in the smart contract system. By reflecting the distribution terms in the smart contract system, the terms can therefore be defined once, and the rest is automated.

The fourth module or subsystem of the decentralized distribution system for digital media is a block chain, such as an Ethereum block chain, that records the smart contracts and executes the smart contracts in a secure, distributed environment.

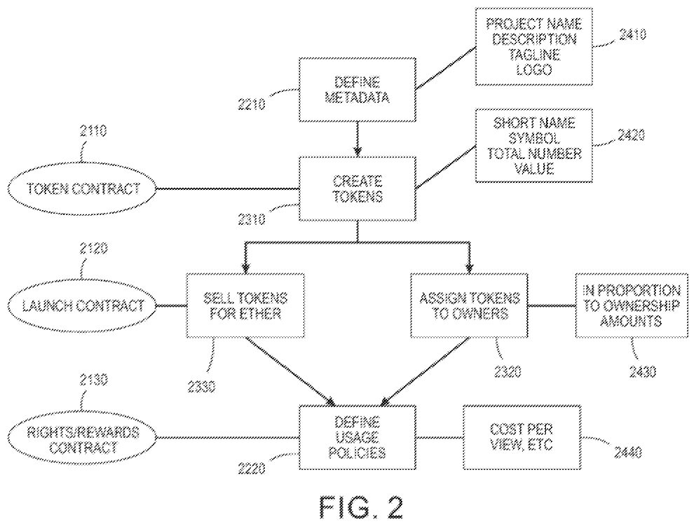

FIG. 2 illustrates a block diagram of the decentralized distribution system for digital media discussed above. As illustrated in FIG. 2, a user (artist/creator) creates, through the user interface, a project; names the project; and may provide a description thereof and/or a logo (image), at block 2410. This information is stored or defined in a metadata file, at block 2210.

After a project is created, the metadata file is utilized in creating tokens for the created project, at block 2310. The created tokens (or cryptotokens) store value and utility internal to a project. At block 2420, the user may give the token(s) a name and a short symbol that can be used to look it up. At this point, the project creators (owners) also choose how many tokens to issue and the expected value of tokens.

The tokens are governed by a token contract (smart contract), at block 2110. The token contract will be discussed in more detail below.

At block 2320, the tokens, through the user interface, can be assigned. For example, as provided for in block 2430, the tokens can be assigned proportionally to ownership amounts.

In another scenario, the tokens can be assigned to the owners or producers of the project and to others proportional to their involvement in the project.

The assignment of tokens is substantially the same as assigning rights. Since the tokens represent the intellectual property of a project and the terms and conditions thereof, the tokens represent the rights, revenue, royalty, and rewards flow as well.

For any unassigned tokens, these tokens can be “sold” for Ether or other digital currency. This release of a proportion of the tokens for public “sale” allows members of the general public to demonstrate an interest in a project and, eventually, if everything works out, share in its success.

The selling of the unassigned tokens are governed by a launch contract (smart contract), at block 2120. The launch contract will be discussed in more detail below.

At block 2220, usage policies, such as the terms under which others can interact with the project, are defined by the user at block 2440, through the user interface. For example, if the project is a movie, interaction would be watching the movie and the cost associated therewith. Other forms of interaction might be possible, such as downloading, reusing, or broadcasting the content.

The usage policies are governed by a rights/reward contract (smart contract), at block 2130. The rights/reward contract will be discussed in more detail below.

Previously configured items can also be edited at block 2220 because the usage terms may not be defined until very late in the process, after a film or music video (for example) is complete or nearly so. Other actions, such as issuing tokens, take place much earlier in the project life cycle, especially if tokens are being used to raise the funds needed to complete the project.

As noted above, the tokens and terms of the project are governed by smart contracts.

The token contract is a smart contract that acts as the token ledger. Within the token contract, the amount of tokens each address holds is internally stored, and through the token contract's different functions, tokens can be transferred from one address to another. Since the token contract is a block chain based system, the addresses of the token contract belong to some entity, such as a person or a company. The block chain records the ownership and the amounts of ownership (as established above). In this embodiment, the tokens relate to funds distribution.

The launch contract is created when tokens are put up for consumption by the public or private parties. When all the tokens associated with a project are pre-allocated, there is no need for a launch campaign to raise more funds.

The launch contract is assigned the tokens created for the fund raising campaign for the project. In the event that a launch of tokens takes place, Ether or other digital currency sent to the launch contract will trigger a return of project tokens of equal value. After the launch of these tokens is complete, the Ether or other digital currency collected will be sent to the configured beneficiary address (usually the token creator, unless otherwise specified during the creation) if the launch met its fundraising goal.

The rights/reward contract mediates rights, revenue, royalty, and reward acquisition and sharing. Ether or other digital currency can be deposited by any external address.

The deposits may include the proceeds from the sale of tokens, which go directly to the project creator so as to be used to build or create the project. The deposits may also include the proceeds from donations from people sympathetic to a particular project, which may go directly to the project creator so as to be used to build or create the project.

In addition, the deposits may also include the proceeds from payments for the use of the project's result (i.e., displaying a movie), wherein the token holders can withdraw funds associated with the use driven payments in accordance with the rights/reward contract and in proportion to the amount of tokens they hold.

As noted above, the decentralized distribution system for digital media is a multi-layered system that allows flexibility and decentralization in funding, monetizing, and distributing entertainment products such as movies, TV shows, e-books, e-literature, digitalized photos, digitalized artwork, and music—any piece of entertainment or intellectual property that can be digitized in a decentralized way, using block chain technology.

The decentralized distribution system provides functionality through various different interconnected modules, that provide wallet management; user authentication; project creation; a smart contract system deployment for each project (for example an Ethereum smart contract system); rights management mechanisms; on-chain (block chain) payment processing; on-chain (block chain) token (project) registry; token launch tools; peer to peer (video and/or audio) content distribution; channel registry for the peer to peer (video and/or audio) content distribution; and application of usage policies to content consumed through the peer to peer (video and/or audio) content distribution.

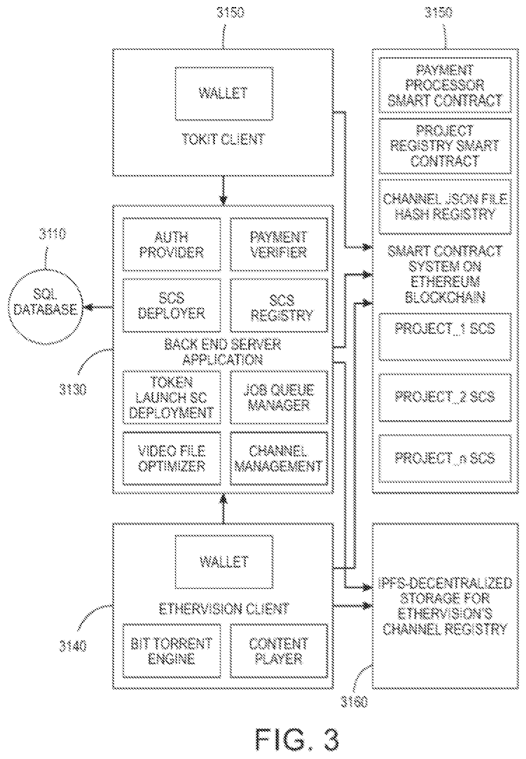

FIG. 3 illustrates an overview of the general architecture of a platform for the decentralized distribution system for digital media of FIG. 2.

As illustrated in FIG. 3, a client or user, using a front end application (“Tokit Client”) or user interface 3120, as described in more detail below with respect to the description of FIGS. 9-27, can create and manage a project for distribution on the decentralized distribution system.

As noted below, the client or user needs a wallet to utilize the front end application or user interface 3120. The wallet can either be created by the user locally, or if the user already has an appropriate wallet, the wallet can be imported into the front end application or user interface 3120.

The front end application or user interface 3120 interacts with a back end server application 3130 or a back end server 3150.

The back end server application 3130 provides support for authenticating a wallet holder; verifying payment for the project creation services and management thereof; deploying the smart contract system for the project; registering the smart contract system with the decentralized distribution system; management of the job queue with respect to the projects; client channel management; token launch smart contract deployment; and video file optimization. These various functions are described in more detail below.

The back end server application 3130 also communicates with a SQL database 3110 to add an entry corresponding to each project created through the front end application or user interface 3120.

Another front end application (“Ethervision Client”) or user interface 3140 enables a user/client to access and/or consume the content on the decentralized distribution system, wherein consumption may include single user or time-limited viewing of the content, single user or time-limited listening of the content, or purchasing of the content. The front end application or user interface 3140 would include access to the user's/client's wallet, a content player, and a BitTorrent Engine.

The front end application or user interface 3140 communicates with the back end server application 3130 and the back end server 3150 to acquire the necessary information and permission to consume the desired content. The front end application or user interface 3140 utilizes the BitTorrent Engine to acquire the content from an InterPlanetary File System 3160, as described in more detail below. The InterPlanetary File System 3160 decentralized storage of the content for distribution over the decentralized distribution system.

The back end server 3150 provides support for the processing of payments through smart contracts, the registration of projects and the projects' smart contracts; registration of channel JavaScript™ object notation file hash, and the managing of the various projects. The smart contracts are supported on Ethereum block chains.

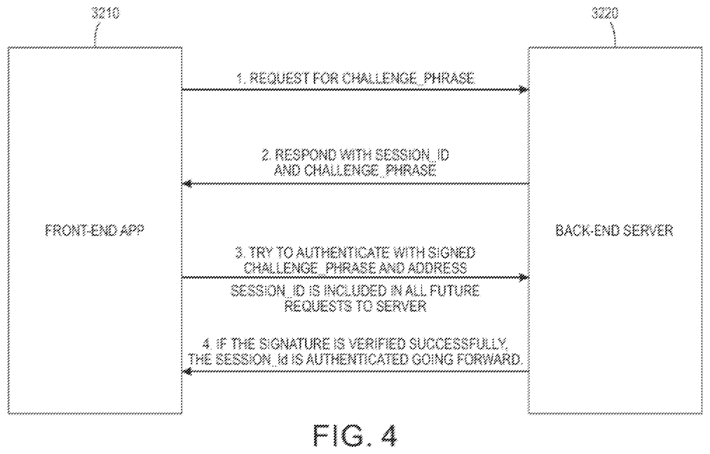

FIG. 4 is a block diagram illustrating a process for authenticating a wallet holder in the decentralized distribution system for digital media.

With respect to FIG. 4, since the decentralized distribution system operates on block chain technology, funds never flow through the servers of the decentralized distribution system. Thus, in order for the user to be able to interact with the block chain based decentralized distribution system; the user needs a private key.

The user interface of the decentralized distribution system allows the user to generate one locally, in their browser without interacting with the servers of the decentralized distribution system.

The users encrypt the private key with password and download it in a special file called “wallet.” Recovery mechanisms through a 12 word mnemonic phrase, using BIP32 or BIP39 can be provided. It is noted that the user's public key and address are derived from their private key.

Once the user's wallet is created or imported in the front-end application (user interface) of the decentralized distribution system, the user can interact with the decentralized distribution system's block chain, namely an Ethereum block chain.

In an Ethereum block chain, addresses are one hundred sixty bit values represented in a forty character long hexadecimal format.

It is further noted that some of the functionalities of the decentralized distribution system are centralized (off-chain, with traditional servers and SQL databases), and some on-chain. This bifurcation of functionalities is to ensure a trust-minimized solution, while maintaining performance benefits of a centralized approach.

To authenticate a wallet holder in the decentralized distribution system, the user needs to prove the user has access to the private key of their address. This authenticated process is illustrated in FIG. 4.

As illustrated in FIG. 4, a user, through a front end application or user interface 3210, queries a back end server 3220 for a challenge phrase to sign. The back end server 3220 creates a session and generates a random thirty-six character long string challenge phrase and returns the challenge phrase and session id to the client via the front end application or user interface 3210.

The client signs, through the front end application or user interface 3210, the challenge phrase using an elliptic curve digital signature algorithm. The front end application or user interface 3210 sends the signature, session id, and its address to the back end server 3220 for verification. The back end server 3220 verifies the elliptic curve digital signature algorithm signature against the claimed address, and if correct, the back end server 3220 authenticates the session id.

Upon completion of this back and forth hand shake, the session_id is considered authenticated by the back end server 3220. The client will include the authenticated session_id in the header in all future requests.

With respect to project management, a user can create a project through the user interface of the decentralized distribution system. The project is an entity that has some elements which are off-chain and some which are on-chain.

For example, off-chain elements are name, description, and/or owner (for listing purposes). On-chain elements are a set of smart contracts that are deployed on Ethereum. Entities can interact with these smart contracts either through the user interface of the decentralized distribution system or programmatically directly with the Ethereum block chain. Each deployed smart contract has a unique address on Ethereum and an application binary interface that describes its functions and attributes.

The decentralized distribution system utilizes ERC20 token contracts with extended functionality to enable external third party applications to be built to work with this token contract and enables the token contract to be connected to rights/rewards contract.

This smart contract acts as the token ledger. Internally, the token contract stores the amount of tokens each address holds in an attribute named ‘mapping (address=>uint256) balances’, and through its different functions, tokens can be transferred from one address to another. The token contract has the following functions, as set forth in the pseudocode below:

- ‘transfer(address _to, uint256 _value)’
- ‘balanceOf(address _owner)’
- ‘approve(address _spender, uint256 _value)’
- ‘allowance(address _owner, address _spender)’
- ‘transferFrom(address _from, address _to, uint256 _value)’

The decentralized distribution system also utilizes rights/rewards smart contracts. The rights/rewards contract acts like a value bucket. Any entity can add ETH (Ethereum's native token), or other ERC20 tokens to this bucket. Only token holders can withdraw value from this bucket, proportional to the number of tokens they hold. The rights/rewards contract has the following functions, as set forth in the pseudocode below:

- ‘depositReward( )’
- ‘withdrawReward( )’
- ‘softWithdrawRewardFor(address forAddress)’

The function, “softWithdrawRewardFor,” is called by the token contract before any transfer, on both addresses involved. The rights/rewards contract keeps the eligible reward at that moment in an internal attribute named ‘owed’, and during the ‘withdrawReward’ called by those addresses, the rights/rewards contract takes amount ‘owed’ to them into account, and resets it afterwards. This mechanism ensures tokens remain fungible even during a transfer.

The rights/rewards contract mediates rights, revenue, royalty, and reward acquisition and sharing.

The decentralized distribution system also utilizes token launch smart contracts. With the token launch contract, project owners can choose to launch their project tokens to the world. The token launch contract handles the logic necessary for exchanging ETH (native Ethereum token) and project tokens.

At the time of the token launch contract's creation (deployment), the owner allocates a number of tokens to it, and specifies the price in ETH (or a specific ERC20 token) of each token. Any entity (address) that sends funds to the token launch contract will receive project tokens in exchange.

After the launch is successfully over, the token launch contract will send the resulting funds to the beneficiary address (usually the owner, unless otherwise specified during the creation, by the owner). In case the token launch contract fails (minimum threshold set during the creation is not reached), any entity that participated can recover their funds.

The token launch contract has the following functions, as set forth in the pseudocode below:

- ‘start( )’
- ‘fund( )’
- ‘withdrawFunding( )’
- ‘withdrawForOwner( )’

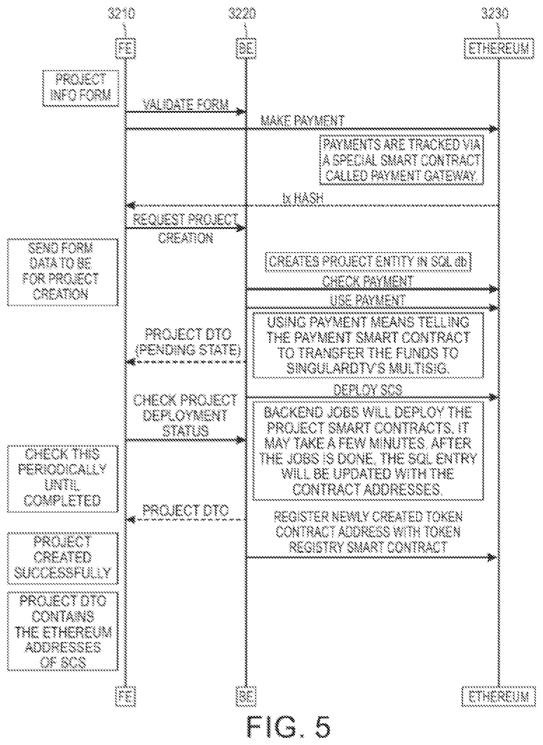

FIG. 5 is a block diagram illustrating a process for creating a project in the decentralized distribution system for digital media. As illustrated in FIG. 5, a user can create a project through the front-end app 3210 or the user interface 3120 of FIG. 3. The user interface 3210 prompts the user for the project name and description and prompts the user for token parameters; i.e., name (e.g. Quantum), abbreviation (aka Token Symbol, e.g. QNTM), and total amount (e.g. 1,000,000). The user chooses a payment method and confirms payment. If the payment is done using US dollars, a payment token (tx hash) is given to the client by a payment gateway (e.g. Stripe).

If the payment is done using ETH, a transaction receipt is returned to the client by a payment smart contract on the Ethereum block chain 3150 of FIG. 3. The user or client send the transaction directly to the payment processor smart contract on the Ethereum block chain 3230 (the Ethereum block chain 3150 of FIG. 3).

The payment receipt (tx hash) is sent to the back end server 3220 alongside with the collected information about the project as part of a project creation request.

The back end server 3220 verifies the payment, and if ok adds the project creation into a job queue and returns a job id to the client.

Upon running the projection creation job, the back end server 3220 adds an entry to a SQL database (SQL database 3110 of FIG. 3) associated with the project and flags the job as pending. The back end server 3220 then deploys two smart contracts (token and rights/rewards), with the appropriate parameters. All the created tokens are allocated to the user (project creator).

When the deployment is done, register the two contracts' addresses are registered in a database, in effect linking the two contracts to the project owner (for listing purposes only).

Also, a transaction is sent to a registry smart contract to register the two newly created smart contracts to user's address. This step ensures an immutable record of every created smart contract system exists on the block chain.

The client can verify the job creation. Once the creation is done, the user can see the newly created project in their user interface's dashboard.

The user can now transfer the newly created tokens to any Ethereum address, using the front end interface 3120 of FIG. 3. Since the tokens are directly linked to a rights/rewards contract, this transfer of tokens represents transfer or rights, effectively turning the front end interface 3120 of FIG. 3 into a rights management gateway.

As described above, the front end interface 3120 of FIG. 3 is a hybrid application, with some functionality performed by a back-end server(s) 3220.

The front end interface 3120 of FIG. 3 uses two global (as opposed to per-project) smart contracts to function properly.

The first global smart contract is a payment processor smart contract which processes payments made in ETH. This smart contract acts as an escrow. The user sends their ETH to the payment processor smart contract, and the payment processor smart contract holds their tokens and registers the payment.

After the back end server completes the project creation job, the payment processor smart contract sends the fund to decentralized distribution system's cold storage and marks user's payment as “used.” This payment mechanism makes everything as asynchronous as possible, and prevents user fund losses in case of browser crashes or any other technical problems on user's end.

The payment processor smart contract has the following function, as represented by pseudocode below:

- ‘depositPayment( )’ #called by user to make a payment
- ‘getUserDeposit(address _user) returns int’ #called by our server
to check the deposited funds by _user
- ‘consumeUserDeposit(address _user) onlyServer’ #called after
the creation job is done. This may have a modifier that requires a
private key to execute it.
- ‘returnUserDeposit(address _user) onlyServer’ #a user can ask to
cancel his deposit and get money back

The second global smart contract is a project registry smart contract. Whenever a new project smart contract system is created, the project smart contract system is registered that into this registry (project registry smart contract). The front-end app gets the list of current user's projects from this registry (project registry smart contract).

This registry (project registry smart contract) is used as opposed to just the SQL database to make the platform is more decentralized, and less prone to censorship.

The project registry smart contract has the following function, as represented by pseudocode below:

- ‘set(address _user, address _token, address _fund)’ #Internally
registers these values in a map with the key being the user
address, _fund is the rights/rewards contract
- ‘get(address _user)’ #queries the registry about user smart
contract system addresses, can return multiple pairs of (token,
fund)

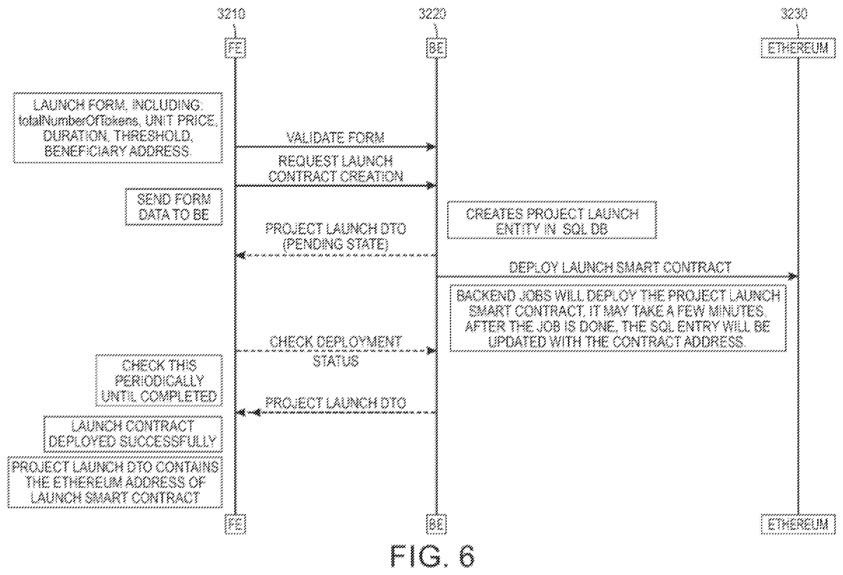

FIG. 6 is a block diagram illustrating a process for launching a created token on the decentralized distribution system for digital media. As illustrated in FIG. 6, after the project has been created, a user can launch their tokens to the world. If the user chooses to do that, the user is prompted, by the front end 3210, for total number of tokens the user wants to sell and the price of each token denominated in ETH. The user sets the duration of the launch and the user can set a minimum threshold and an external address to which the funds go.

After these values are collected, a request is sent from the front end 3210 to the back end server 3220 with the collected parameters. The back end server 3220 adds a job for the token launch contract deployment. The token launch contract deployment is sent to the Ethereum block chain 3230.

After the deployment of the token launch contract, the project will have three smart contracts.

The token launch smart contract has a public method named ‘fund( )’ which accepts ETH (ethereum native token). This method calculates the corresponding tokens and sends them to the address of the entity calling it.

An example of pseudocode of a launch contract is as follows:

import “AbstractSingularDTVToken.sol”;
import “AbstractSingularDTVFund.sol”;
/// @title Token Creation contract - Implements token creation functionality.
/// @author Stefan George - <stefan.george@consensys.net>
contract SingularDTVCrowdfunding {

/*
* External contracts
*/
SingularDTVToken public singularDTVToken;
SingularDTVFund public singularDTVFund;
/*
* Constants
*/
uint constant public CAP = 1000000000; // 1B tokens is the maximum amount of

tokens

uint constant public CROWDFUNDING_PERIOD = 4 weeks; // 1 month
uint constant public TOKEN_LOCKING_PERIOD = 2 years; // 2 years
uint constant public TOKEN_TARGET = 534000000; // Goal threshold
/*
* Enums
*/
enum Stages {

CrowdfundingGoingAndGoalNotReached,
CrowdfundingEndedAndGoalNotReached,
CrowdfundingGoingAndGoalReached,
CrowdfundingEndedAndGoalReached

}
/*
* Storage
*/
address public owner;
uint public startDate;
uint public fundBalance;
uint public baseValue = 1250 szabo; // 0.00125 ETH
uint public valuePerShare = baseValue; // 0.00125 ETH
// participant address => value in Wei
mapping (address => uint) public investments;
// Initialize stage
Stages public stage = Stages.CrowdfundingGoingAndGoalNotReached;
/*
* Modifiers
*/
modifier noEther( ) {

if (msg.value > 0) {

throw;

}
_{—}

}
modifier onlyOwner( ) {

// Only owner is allowed to do this action.
if (msg.sender != owner) {

throw;

}
_{—}

}
modifier minInvestment( ) {

// User has to send at least the ether value of one token.
if (msg.value < valuePerShare) {

throw;

}
_{—}

}
modifier atStage(Stages _stage) {

if (stage != _stage) {

throw;

}
_{—}

}
modifier atStageOR(Stages _stage1, Stages _stage2) {

if (stage != _stage1 && stage != _stage2) {

throw;

}
_{—}

}
modifier timedTransitions( ) {

uint crowdfundDuration = now - startDate;
if (crowdfundDuration >= 22 days) {

valuePerShare = baseValue * 1500 / 1000;

}
else if (crowdfundDuration >= 18 days) {

valuePerShare = baseValue * 1375 / 1000;

}
else if (crowdfundDuration >= 14 days) {

valuePerShare = baseValue * 1250 / 1000;

}
else if (crowdfundDuration >= 10 days) {

valuePerShare = baseValue *1125 / 1000;

}
else {

valuePerShare = baseValue;

}
if (crowdfundDuration >= CROWDFUNDING_PERIOD) {

if (stage == Stages.CrowdfundingGoingAndGoalNotReached) {

stage = Stages.CrowdfundingEndedAndGoalNotReached;

}
else if (stage == Stages.CrowdfundingGoingAndGoalReached) {

stage = Stages.CrowdfundingEndedAndGoalReached;

}

}
_{—}

}
/*
* Contract functions
*/
/// dev Validates invariants.
function checkInvariants( ) constant internal {

if (fundBalance > this.balance) {

throw;

}

}
/// @dev Can be triggered if an invariant fails.
function emergencyCall( )

external
noEther
returns (bool)

{

if (fundBalance > this.balance) {

if (this.balance > 0 && !singularDTVFund.workshop( ).send(this.balance)) {

throw;

}
return true;

}
return false;

}
/// @dev Allows user to create tokens if token creation is still going and cap not

reached. Returns token count.

function fund( )

external
timedTransitions
atStageOR(Stages.CrowdfundingGoingAndGoalNotReached,

Stages.CrowdfundingGoingAndGoalReached)

minInvestment
returns (uint)

{

uint tokenCount = msg.value / valuePerShare; // Token count is rounded down.

Sent ETH should be multiples of valuePerShare.

if (singularDTVToken.totalSupply( ) + tokenCount > CAP) {

// User wants to create more tokens than available. Set tokens to possible

maximum.

tokenCount = CAP − singularDTVToken.totalSupply( );

}
uint investment = tokenCount * valuePerShare; // Ether spent by user.
// Send change back to user.
if (msg.value > investment && !msg.sender.send(msg.value − investment)) {

throw;

}
// Update fund's and user's balance and total supply of tokens.
fundBalance += investment;
investments[msg.sender] += investment;
if (!singularDTVToken.issueTokens(msg.sender, tokenCount)) {

// Tokens could not be issued.
throw;

}
// Update stage
if (stage == Stages.CrowdfundingGoingAndGoalNotReached) {

if (singularDTVToken.totalSupply( ) >= TOKEN_TARGET) {

stage = Stages.CrowdfundingGoingAndGoalReached;

}

}
// not an else clause for the edge case that the CAP and TOKEN_TARGET are

reached in one call

if (stage == Stages.CrowdfundingGoingAndGoalReached) {

if (singularDTVToken.totalSupply( ) == CAP) {

stage = Stages.CrowdfundingEndedAndGoalReached;

}

}
checkInvariants( );
return tokenCount;

}
/// @dev Allows user to withdraw ETH if token creation period ended and target was

not reached. Returns success.

function withdrawFunding( )

external
noEther
timedTransitions
atStage(Stages.CrowdfundingEndedAndGoalNotReached)
returns (bool)

{

// Update fund's and user's balance and total supply of tokens.
uint investment = investments[msg.sender];
investments[msg.sender] = 0;
fundBalance −= investment;
// Send ETH back to user.
if (investment > 0 && !msg.sender.send(investment)) {

throw;

}
checkInvariants( );
return true;

}
/// @dev Withdraws ETH to workshop address. Returns success.
function withdrawForWorkshop( )

external
noEther
timedTransitions
atStage(Stages.CrowdfundingEndedAndGoalReached)
returns (bool)

{

uint value = fundBalance;
fundBalance = 0;
if (value > 0 && !singularDTVFund.workshop( ).send(value)) {

throw;

}
checkInvariants( );
return true;

}
/// @dev Sets token value in Wei.
/// @param valueInWei New value.
function changeBaseValue(uint valueInWei)

external
noEther
onlyOwner
returns (bool)

{

baseValue = valueInWei;
return true;

}

/// @dev Returns true if 2 years have passed since the beginning of token creation

period.

function twoYearsPassed( )

constant
external
noEther
returns (bool)

{

return now − startDate >= TOKEN_LOCKING_PERIOD;

}
/// @dev Returns if token creation ended successfully.
function campaignEndedSuccessfully( )

constant
external
noEther
returns (bool)

{

if (stage == Stages.CrowdfundingEndedAndGoalReached) {

return true;

}
return false;

}
// updateStage allows calls to receive correct stage. It can be used for transactions

but is not part of the regular token creation routine.

// It is not marked as constant because timedTransitions modifier is altering state and

constant is not yet enforced by solc.

/// @dev returns correct stage, even if a function with timedTransitions modifier has

not yet been called successfully.

function updateStage( )

external
timedTransitions
noEther
returns (Stages)

{

return stage;

}
/// @dev Setup function sets external contracts' addresses.
/// @param singularDTVFundAddress Crowdfunding address.
/// @param singularDTVTokenAddress Token address.
function setup(address singularDTVFundAddress, address

singularDTVTokenAddress)

external
onlyOwner
noEther
returns (bool)

{

if (address(singularDTVFund) == 0 && address(singularDTVToken) == 0) {

singularDTVFund = SingularDTVFund(singularDTVFundAddress);
singularDTVToken = SingularDTVToken(singularDTVTokenAddress);
return true;

}
return false;

}
/// @dev Contract constructor function sets owner and start date.
function SingularDTVCrowdfunding( ) noEther {

// Set owner address
owner = msg.sender;
// Set start-date of token creation
startDate = now;

}
/// @dev Fallback function always fails. Use fund function to create tokens.
function ( ) {

throw;

}

}

The Token Launch contract has a state machine, with the following possible

stages represented by the pseudocode below:

Stages {
Deployed,
GoingAndGoalNotReached,
EndedAndGoalNotReached,
GoingAndGoalReached,
EndedAndGoalReached
}

The default stage is ‘Deployed’. In order for fundraising campaign to start (change to ‘GoingAndGoalNotReached’), a transaction is sent by the owner, calling the ‘start( )’ method. The ‘startTime’ is set in the ‘start( )’ method. After that, everything is automated and the owner cannot change the behaviors. Any Ethereum entity can participate in the token launch. The user interface allows anyone to create a wallet and participate. This can be realized by a dedicated page for each project token launch.

The project owner can customize the dedicated token launch page with a WYSIWYG editor, allowing the owner to upload images, embed videos, and add content to promote the project.

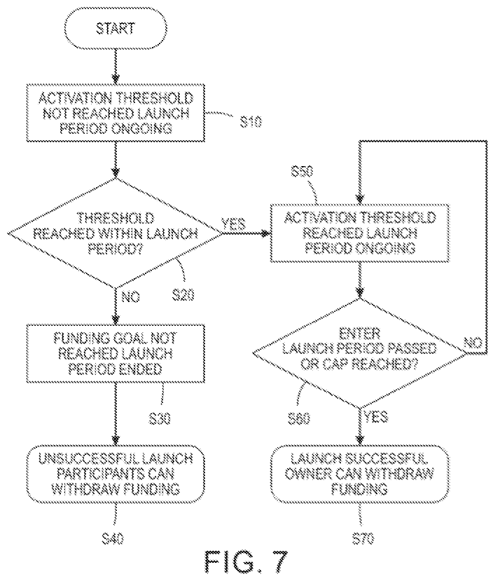

The state, as illustrated in FIG. 7, can be changed if there is a minimum threshold set by the owner during the creation (step S10), and that threshold is not reached at the end of “launch duration” (step S20). In this situation, the state will change to ‘EndedAndGoalNotReached’ (step S30) and all entities that participated in the token launch, will be able to get their ETH back through ‘withdrawFunding( )’ method (step S40).

If the maximum duration has not been reached (step S60), and minimum threshold is reached (Step S50), the state will change to ‘GoingAndGoalReached’.

After the duration of the launch has been reached, if the minimum threshold has been reached, the state changes to ‘EndedAndGoalReached’ (step S70).

It is noted that the user interface interacts with the launch smart contract directly, and not through the back end server.

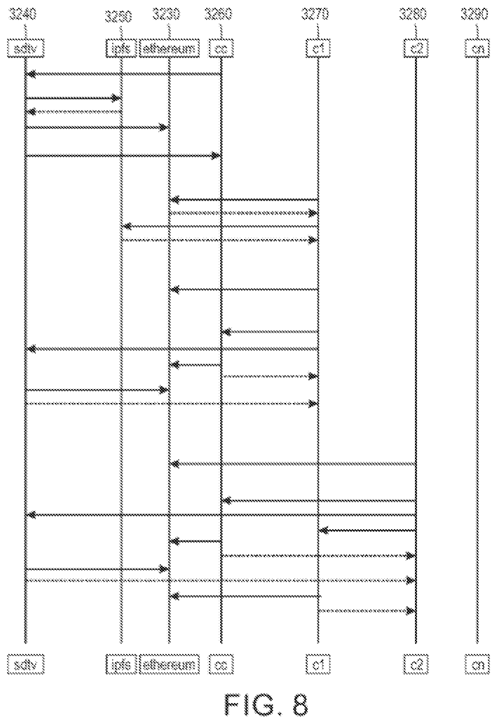

FIG. 8 is a block diagram illustrating a process for content distribution on the decentralized distribution system for digital media.

As illustrated in FIG. 8, a client channel 3260 notifies the decentralized distribution system 3240 that a new file (content) should be added to a channel. The decentralized distribution system 3240 uploads, to the InterPlanetary File System 3250, JavaScript™ object notation data about the channel and new filed associated therewith.

The InterPlanetary File System 3250 creates a hash corresponding to JavaScript™ object notation data and communicates the hash to the decentralized distribution system 3240. The decentralized distribution system 3240 registers the channel InterPlanetary File System hash in the appropriate registry smart contract.

Optionally, the decentralized distribution system 3240 may download the content to the channel, thereby seeding the newly created content (files) from the content creators.

An Ethervision client (c1) 3270, in searching for content, requests the channel file location from the associated registry smart contract. The Ethereum block chain 3230 provides the Ethervision client (c1) 3270 with the channel InterPlanetary File System hash. The Ethervision client (c1) 3270 uses the channel InterPlanetary File System hash to request the channel data from the InterPlanetary File System 3250. The InterPlanetary File System 3250 provides the Ethervision client (c1) 3270 with the channel JavaScript™ object notation data.

Upon reviewing the channel JavaScript™ object notation data, the Ethervision client (c1) 3270 decides to purchase or consume the content of the channel according to the usage policy of the content. To purchase or consume the content of the channel according to the usage policy of the content, the Ethervision client (c1) 3270 provides a payment to the Ethereum block chain 3230.

The Ethervision client (c1) 3270 may provide a request to the client channel 3260 for a BitTorrent download or may provide a request to the decentralized distribution system 3240 for a BitTorrent download. In addition, the Ethervision client (c1) 3270, optionally, may provide a request to other peers, such as other Ethervision clients, for a BitTorrent download or, optionally, may provide a request to a data distribution service server for a BitTorrent download.

The client channel 3260 and/or the decentralized distribution system 3240, in response to a BitTorrent download request, communicate with the Ethereum block chain 3230 to determine if proper payment has been received.

If the proper payment has been received, the client channel 3260 and/or the decentralized distribution system 3240 allow a BitTorrent stream to the Ethervision client (c1) 3270.

An Ethervision client (c2) 3280, in searching for content, requests the channel file location from the associated registry smart contract. The Ethereum block chain 3230 provides the Ethervision client (c2) 3280 with the channel InterPlanetary File System hash. The Ethervision client (c2) 3280 uses the channel InterPlanetary File System hash to request the channel data from the InterPlanetary File System 3250. The InterPlanetary File System 3250 provides the Ethervision client (c2) 3280 with the channel JavaScript™ object notation data.

Upon reviewing the channel JavaScript™ object notation data, the Ethervision client (c2) 3280 decides to purchase or consume the content of the channel according to the usage policy of the content.

To purchase or consume the content of the channel according to the usage policy of the content, the Ethervision client (c2) 3280 provides a payment to the Ethereum block chain 3230.

The Ethervision client (c2) 3280 may provide a request to the client channel 3260 for a BitTorrent download or may provide a request to the decentralized distribution system 3240 for a BitTorrent download. In addition, the Ethervision client (c2) 3280, optionally, may provide a request to other peers, such as other Ethervision clients, for a BitTorrent download or, optionally, may provide a request to a data distribution service server for a BitTorrent download.

The client channel 3260 and/or the decentralized distribution system 3240, in response to a BitTorrent download request, communicate with the Ethereum block chain 3230 to determine if proper payment has been received.

If the proper payment has been received, the client channel 3260 and/or the decentralized distribution system 3240 allow a BitTorrent stream to the Ethervision client (c2) 3280.

An Ethervision client (c3) 3290, in searching for content, requests the channel file location from the associated registry smart contract. The Ethereum block chain 3230 provides the Ethervision client (c3) 3290 with the channel InterPlanetary File System hash. The Ethervision client (c3) 3290 uses the channel InterPlanetary File System hash to request the channel data from the InterPlanetary File System 3250. The InterPlanetary File System 3250 provides the Ethervision client (c3) 3290 with the channel JavaScript™ object notation data.

Upon reviewing the channel JavaScript™ object notation data, the Ethervision client (c3) 3290 decides to purchase or consume the content of the channel according to the usage policy of the content. To purchase or consume the content of the channel according to the usage policy of the content, the Ethervision client (c3) 3290 provides a payment to the Ethereum block chain 3230.

The Ethervision client (c3) 3290 may provide a request to the client channel 3260 for a BitTorrent download or may provide a request to the decentralized distribution system 3240 for a BitTorrent download. In addition, the Ethervision client (c3) 3290, optionally, may provide a request to other peers, such as other Ethervision clients, for a BitTorrent download or, optionally, may provide a request to a data distribution service server for a BitTorrent download.

The client channel 3260 and/or the decentralized distribution system 3240, in response to a BitTorrent download request, communicate with the Ethereum block chain 3230 to determine if proper payment has been received.

If the proper payment has been received, the client channel 3260 and/or the decentralized distribution system 3240 allow a BitTorrent stream to the Ethervision client (c3) 3290.

The content distribution module 3140 of FIG. 3 may a standalone desktop or mobile app that allows a user to play video and audio content provided by the content providers of the decentralized distribution system.

The content provider, a project creator using the front end 3120 of FIG. 3, uploads the video or audio onto the decentralized distribution system. Since the distribution is done peer-to-peer, using, for example, BitTorrent technology, content creators are responsible for “seeding” their files, so others peers can download the files from the decentralized distribution system.

Each entity may have a channel on the decentralized distribution system, and each channel can have any number of video or audio content. The decentralized distribution system may have an official, curated channel. Adding content to a channel can be done by the owner of the channel or someone who has been given access by the owner.

Adding a video or audio file to the decentralized distribution system is done by going through a step-by-step wizard provided by the decentralized distribution system's user interface. Initially, a user is prompted for the name, description, category, and tags of the content. The user is then prompted for the address of the project token.

A user is queried to set usage policy for the content. An example would be cost for adding it to library, or cost per view. The content file can be selected (or dragged into the app or user interface). If the file format is not optimal, the file can be sent to the back end server to be converted to an optimized format using an appropriate codec (h264) and sent back to the client.

The file is added to client's BitTorrent library, and a magnet link is generated for the file. Magnet links are links with no files associated with them, just data. The links are an URI standard developed primarily to be used by p2p networks.

Magnet links differ from URLs, for example, in that magnet links do not hold information on the location of a resource but rather on the content of the file or files to which the magnet links link.

Magnet links are made up of a series of parameters containing various data in no particular order. In the case of BitTorrent, the magnet link holds the hash value of the torrent which is then used to locate copies of the files among the peers. The magnet links may also hold filename data or links to trackers used by the torrent.

With magnet links, BitTorrent indexers do not have to store any files, just a few snippets of data. Magnet links can be copy-pasted as plain text by users and shared via email, instant messages, or any other medium.

The magnet link, together with all the information gathered during the content upload is sent to the back end server for registering the newly added content.

The registration is done by adding the newly created item to the SQL database. A complete list of every channel in the database and all their videos is generated in JavaScript™ object notation format. The resulting JavaScript™ object notation file is uploaded to an InterPlanetary File System. The resulting InterPlanetary File System hash is sent to a registry smart contract. This results in a completely decentralized distribution system.

When a user wants to update its channel and content list, the user queries the registry smart contract about the list hash. The decentralized distribution system fetches the list from InterPlanetary File System by hash and updates its internal channel list using the JavaScript™ object notation file.

Using the magnet links of the content files, the user, by connecting to each other, can fetch bits and pieces of each file. The more popular a file, the more people seeding it, and a smoother playing experience.

For less popular files, content providers can add more dedicated peers to host their files.

The user interface of the decentralized distribution system will have the wallet management module integrated into it so that viewers can browse either from the curated official channel or from unofficial channels.

When the user wants to “play” a video or audio content, the user interface of the decentralized distribution system checks the monetization policy of the content provider, and initiates a transaction, sending value tokens to the content's rights/rewards smart contract (inferred from the content's token contract).

The payment is registered in the project's rights/rewards smart contract, and other users can check and see if someone trying to download a file from them has really paid for that content or not. If not, they can refuse to accept that client as a downloader.

The decentralized distribution system, described above, allows uses and rights to be managed in more complex ways than would be possible with a cryptocurrency which do not support smart contracts. Rights are not merely registered to a block chain address but are programmed to respond to conditions.

With a smart contract system and the associated cryptotoken ecosystem, it is possible, for example, to set up terms where purchasing the right to stream two movies automatically gives the customer tokens (in this context, reward points) toward purchase of a book. The data and logic allowing this is all stored within the smart contracts involved, with the underlying block chain acting merely as a log.

An example of how decentralized distribution system may be used, consider the case of three film-school students, Alice, Bob, and Eve who have agreed to make a short film together. They determine that they need $20,000 to achieve their goal, but they only have $10,000. Alice puts in $4,000, Bob puts in $4,000, and Eve puts in $2,000. This is only half of what they budgeted for their short film project so they come to the decentralized distribution system and set up a project.

They name the project “Short Film Project” and give it a short description. Alice takes the lead as the producer and custodian of the money. She creates a token called SHRTFLM, issuing 20,000 tokens at $1 of value per token. Of those, 4,000 are reserved to Alice, 4,000 are reserved for Bob, and 2,000 tokens for Eve. The tokens represent the dollar value they contributed to their film.

As the money manager for the project, Alice takes possession of the SHRTFLM tokens and sends the correct amounts to Bob and Eve as well as assigns the 10,000 unallocated tokens to the Launch Contract. Sending the tokens where they need to go could be automated but giving Alice maximum control to adjust amounts as needed in the early stages is an important measure for building confidence in a process that may be unfamiliar to all involved.

The other 10,000 tokens are used in a funding campaign. Their goal is to raise the other $10,000 that they need to make their short film. Anyone with an Internet connection and browser can go to the decentralized distribution system site and trade Ether for SHRTFLM tokens in a dollar for dollar swap. That is, if Ether is selling at the time for $50 each, then one Ether acquires fifty SHRTFLM tokens. A launch contract is created when the project is created and then deployed to manage this fund raising effort.

When they reach their goal, the campaign contract automatically sends $10,000 worth of Ether to Alice's address so she can withdraw it and use the proceeds to make the short film. It is low budget by studio standards but quite well financed for a student project.

Rather than release their masterpiece to theaters or a digital platform like Netflix™, the three partners upload the finished product to the decentralized distribution system, in order to use its capabilities to make the movie available for streaming viewers. They require that people who wish to see the movie to purchase a predetermined amount of Ether (paid into the rights/rewards Contract), which will give them twenty-four hours to view the movie as many times as they like.

The price is low by theater standards, where distributors and staff must be paid out of ticket sales. The price is also too low for it to be economical to take credit cards. A cryptocurrency-based system removes these obstacles.

Payments for viewing the movie go directly to the rights/rewards smart contract which automatically calculates what portion of the proceeds any given entity (as determined by its address) is entitled to withdraw.

Since the contract code is registered on the block chain and immutable, there is no possibility for creative accounting techniques to alter anyone's payout.

The rights/rewards smart contract executes against the known funds and everyone is able to withdraw exactly the correct proportion.

As utilized above, the block chain technology utilizes a distributed database that includes and maintains an ever growing list of data records. Being distributed, block chain technology improves data recording technology by making data recording effectively tamper and revision proof. For example, utilizing block chain technology as described above, public ledgers of transactions for cryptocurrencies, such as bitcoin, name-coin, and so on are made effectively tamper and revision proof.

In other words, conventional technologies required data (transaction) recording to be done on a private platform to effectively prevent undesired tampering or revisions of the data, whereas utilizing the block chain technology as described above, data (transaction) recording can be effectively moved off a private platform to a public platform, thereby allowing data transparency while effectively preventing undesired tampering or revisions of the recorded data.

Moreover, block chain technology, as described above, enables decentralized digital currencies, because bitcoin transactions are verified by network nodes (e.g., addresses), and recorded in the public, distributed ledgers.

Furthermore, block chain technology, as described above, with the use of a peer-to-peer network and a distributed timestamping server, block chain technology manages autonomously such that a block chain is a distributed ledger that can record transactions efficiently and in a verifiable and permanent way. The ledger can also be programmed to trigger transactions automatically.

Moreover, in the various embodiments described above, unlike conventional platforms, where format and delivery limitations require the various content verticals (Film, TV, Books, Music, etc.) to be siloed into different sections of the user interface, the above-described transactional platform allows for the mixing of content verticals in the same user experience, whereby related titles in various content verticals can be displayed in the same search and can be bundled together into cohesive channels.

In addition, the various embodiments described above, block chain technology is utilized to reduce the gap time from the point of sale to the disbursement of revenues due to the nature of decentralized ledger technology, allowing revenue to be accounted for quickly and immutably, thereby effectively eliminating the need for paper statements and seasonal audits.

The above described utilization of the block chain technology and decentralized distributive system provides multi-layer content security, which provides stronger anti-piracy and content security measures than conventional industry standard protocols.

Furthermore, the above described utilization of the block chain technology and decentralized distributive system enables transparency of transactions, due to logging on a public block chain, to provide more insight into the data around content ownership.

Also, the above described utilization of the block chain technology and decentralized distributive system provides streamlined digital rights management though peer-to-peer content distribution and delivery, thereby removing intermediary bodies from the process of digital rights management and removing points of obfuscation from the process.

The above described utilization of the block chain technology and decentralized distributive system provides an intellectual property rights owner the ability to license content directly to the end user, streamlining the process and providing the intellectual property rights owner with more data surrounding content usage than provided by conventional systems.

The above described utilization of the block chain technology and decentralized distributive system also allows global access to content for the end user within the same software application, thereby avoiding the need to launch applications in each territory and struggle with regional challenges. The above described utilization of the block chain technology and decentralized distributive system provides the ability to avoid censorship, with a base layer of content deliverable accessible to all, regardless of regional censors and restrictions.

FIG. 9 illustrates a workflow for the above-described decentralized distributive system, wherein various encryption methods are used as a content file (media) flows from a content owner (provider) to a user desiring to consume or purchase the content file.

In the following description, a peer-to-peer network is defined as a group of computers (a computer being defined as a physical tangible machine having a physical tangible processor, physical tangible memory, and a physical tangible communication interface) that are connected to each other across the internet via software. A peer-to-peer network does not have a central server (a server being defined as a physical tangible machine having a physical tangible processor, physical tangible memory, and a physical tangible communication interface) that connects to each computer, but rather all the computers are connected to all the other computers. Data is transmitted across and/or between two computers on the network directly, not via a centralized hub (server).

In the following description, a network provides wired, wireless, optical, and/or any combination thereof communication between computers, servers, and/or electronic devices.

In the following description, peer is defined as a computer on a peer-to-peer network that hosts files and shares the files with other computers on the peer-to-peer network.

In the following description, leecher is defined as a computer on a peer-to-peer network that only draws files from the peer-to-peer network and does not pass the files along to other computers on the peer-to-peer network.

In the following description, seeder is defined as a computer at a front end of a peer-to-peer network that only feeds files to the peer-to-peer network and does not receive files from computers (peers) on the peer-to-peer network, unless the peer is associated with a content owner who desires to upload a content file to the decentralized distributive system.

In the following description, public/private key encryption is defined as an encryption protocol which utilizes two keys to secure a file—a public key and private key pair. Any file encrypted with a public key can only be decrypted digital content file with the associated private key.

Conventional industry standard encryption works by encrypting full content files with a designated encryption key. Conventionally, when a user purchases or rents content, the purchase is registered on a central database and the decryption key is sent to the user. In these conventional systems, all users on a given distribution platform (e.g., iTunes™) are given the same decryption key. Thus, the encryption is specific to a piece of content, but the same for every user who purchases or rents that piece of content. In other words, on iTunes™ there is a single Jurassic Park™ decryption key, a single Avengers™ decryption key, etc.

As illustrated in FIG. 9, the above-described decentralized distributive system is realized on a peer-to-peer network for content delivery. The network may be a modified torrent-style network which allows peers on the network to hold both full content files (video, audio, and eBooks) and partial files which are combined at an endpoint.

Content is seeded into the network from cloud storage (e.g., AWS S3) and hosted on computers around the world (“peers”). Content is delivered to end users (leechers or peers) from the closest available peer on the network, thus optimizing delivery time.

In order to protect the rights of the content owners, encryption is individually applied to full or partial files throughout the network with a private key not known to the user.

In the network illustrated in FIG. 9, each peer on the peer-to-peer network is assigned a unique and secret public/private key pair via a crypto-wallet (a crypto-wallet is a separate electronic wallet from the electronic wallet, discussed above, which is used to purchase or rent content).

As illustrated in FIG. 9, a content owner 5000 uploads a content file MF.mp4 (such as an audio file, video file, eBook, etc.) to the cloud or internet for inclusion (availability) on the above described decentralized distributive system. Although distributive system is decentralized, a host oversees the administration of the decentralized distributive system. The content file MF.mp4 is encrypted using Layer 1 encryption and a public key owned by the host (administrator of the decentralized distributive system) 5500 and transmitted to seeder computers (6100 and 6200) as content file MF.EV.

Since the content file MF.mp4 is encrypted using the public key owned by the host (administrator of the decentralized distributive system) 5500, the Layer 1 encrypted content file MF.EV can only be decrypted using the private key of the host (administrator of the decentralized distributive system) 5500.

Once the seeder computers (6100 and 6200) receives the Layer 1 encrypted content file MF.EV, the Layer 1 encrypted content file MF.EV is decrypted using the private key of the host (administrator of the decentralized distributive system) 5500. Thereafter, the decrypted content file MF.EV is encrypted with Layer 3 encryption using a public key associated with the seeder computer so that the Layer 3 encrypted content file can only be decrypted by the private key of the seeder computer.

For example, as illustrated in FIG. 9, seeder computer 6100 encrypts content file MF.EV using a public key associated with the seeder computer 6100 to create a Layer 3 encrypted content file MF.A.

On the other hand, as illustrated in FIG. 9, seeder computer 6200 encrypts content file MF.EV using a public key associated with the seeder computer 6200 to create a Layer 3 encrypted content file MF.B.

Before the Layer 3 encrypted content files (MF.A or MF.B) are transmitted or passed from, for example, a seeder computer (6100) to a peer computer on the peer-to-peer network, a handshake is done between the seeder computer 6100 and peer computers (7100 and 7300) to prove that the receiving peer controls the private key of the public key that will be used to encrypt the content file MF.mp4 on the computer or electronic device 8000 of the content file purchaser or content file renter.

For example, as illustrated in FIG. 9, the seeder computer 6100 verifies that the receiving the peer computer 7100 has a registered transaction associated with the purchasing or renting of the content file.

If the transaction is authentication or verified, as illustrated in one of the examples of the workflow paths, the seeder computer 6100 removes (decrypts) the Layer 3 encryption from the Layer 3 encrypted content file MF.A to create content file MF.mp4 and encrypts the content file MF.mp4 with Layer 2 encryption using a temporary symmetric key (the temporary symmetric key is a symmetric key exchanged between the two peers) to create Layer 2 encrypted content file MF.A.EV.

When the Layer 2 encrypted content file MF.A.EV is received, as illustrated in FIG. 9, by a first peer computer 7100, the first peer computer decrypts the Layer 2 encrypted content file MF.A.EV to retrieve the unencrypted content file MF.mp4 before encrypting the content file MF.mp4 with Layer 3 encryption using a public key associated with the first peer computer 7100 so that the Layer 3 encrypted content file MF.C can only be decrypted by the private key of the first peer computer 7100, now in possession of the content file.

As illustrated in FIG. 9, the content file MF.mp4 is handled by two peer computers (first peer computer 7100 and second peer computer 7200) in the peer-to-peer network. Before transmitting the Layer 3 encrypted content file MF.C from the first peer computer 7100 to the second peer computer 7200, over the peer-to-peer network, a handshake is done between the first peer computer 7100 and the second peer computer 7200 to prove that the second peer computer 7200 controls the private key of the public key that will be used to encrypt the content file MF.mp4 on the computer or electronic device 8000 of the content file purchaser or content file renter.

In this situation, the first peer computer 7100 verifies that the second peer computer 7200 has a registered transaction associated with the purchasing or renting of the content file MF.mp4.

If the transaction is authentication or verified, the first peer computer 7100 removes (decrypts) the Layer 3 encryption from the Layer 3 encrypted content file MF.C to retrieve the content file MF.mp4 and encrypts the content file MF.mp4 with Layer 2 encryption using a temporary symmetric key (the temporary symmetric key is a symmetric key exchanged between the two peers) to create Layer 2 encrypted content file MF.C.EV.

When the Layer 2 encrypted content file MF.C.EV is received by the second peer computer 7200, the second peer computer 7200 decrypts the Layer 2 encrypted content file MF.C.EV to retrieve the unencrypted content file MF.mp4 before encrypting the content file MF.mp4 with Layer 3 encryption using a public key associated with the second peer computer so that the Layer 3 encrypted content file MF.G can only be decrypted by the private key of the second peer computer 7200, now in possession of the content file.

Before transmitting the Layer 3 encrypted content file MF.G from the second peer computer 7200 to the consumer computer 8000 (the computer or electronic device of the content file purchaser or content file renter), over the peer-to-peer network, a handshake is done between the second peer computer 7200 and the consumer computer 8000 to prove that the consumer computer 8000 controls the private key of the public key that will be used to encrypt the content file MF.mp4 on the consumer computer 8000.

In this situation, the second peer computer 7200 verifies that the consumer computer 8000 has a registered transaction associated with the purchasing or renting of the content file MF.mp4.

If the transaction is authentication or verified, the second peer computer 7200 removes (decrypts) the Layer 3 encryption from the Layer 3 encrypted content file MF.G to retrieve the content file MF.mp4 and encrypts the content file MF.mp4 with Layer 2 encryption using a temporary symmetric key (the temporary symmetric key is a symmetric key exchanged between the two peers) to create Layer 2 encrypted content file MF.G.EV.

When the Layer 2 encrypted content file MF.G.EV is received by the consumer computer 8000, the consumer computer 8000 decrypts the Layer 2 encrypted content file MF.G.EV to retrieve the unencrypted content file MF.mp4 before encrypting the content file MF.mp4 with Layer 3 encryption using a public key associated with the consumer computer 8000 so that the Layer 3 encrypted content file MF.H can only be decrypted by the private key of the consumer computer 8000, now in possession of the content file.

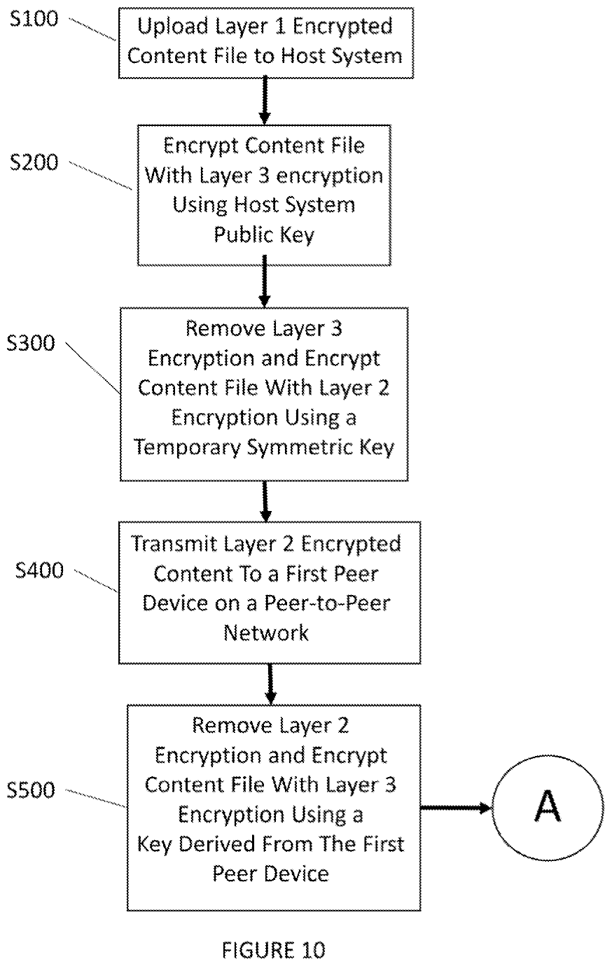

As illustrated in FIG. 10, at step S100, a Layer 1 encrypted content file is uploaded to a host system (cloud). The Layer 1 encrypted content file is decrypted and then encrypted, at step S200, with Layer 3 encryption using a public key of the host system.

Before the content file is placed upon the peer-to-peer network, at step S300, the Layer 3 encryption is removed and the content file is encrypted with Layer 2 encryption using a temporary symmetric key (the temporary symmetric key is a symmetric key exchanged between the two peers).

At step S400, the Layer 2 encrypted content file is transmitted to a peer computer on the peer-to-peer network. When the peer computer on the peer-to-peer network receives the Layer 2 encrypted content file, at step S500, the peer computer removes the Layer 2 encryption and encrypts the content file with Layer 3 encryption using a key derived from the peer computer.

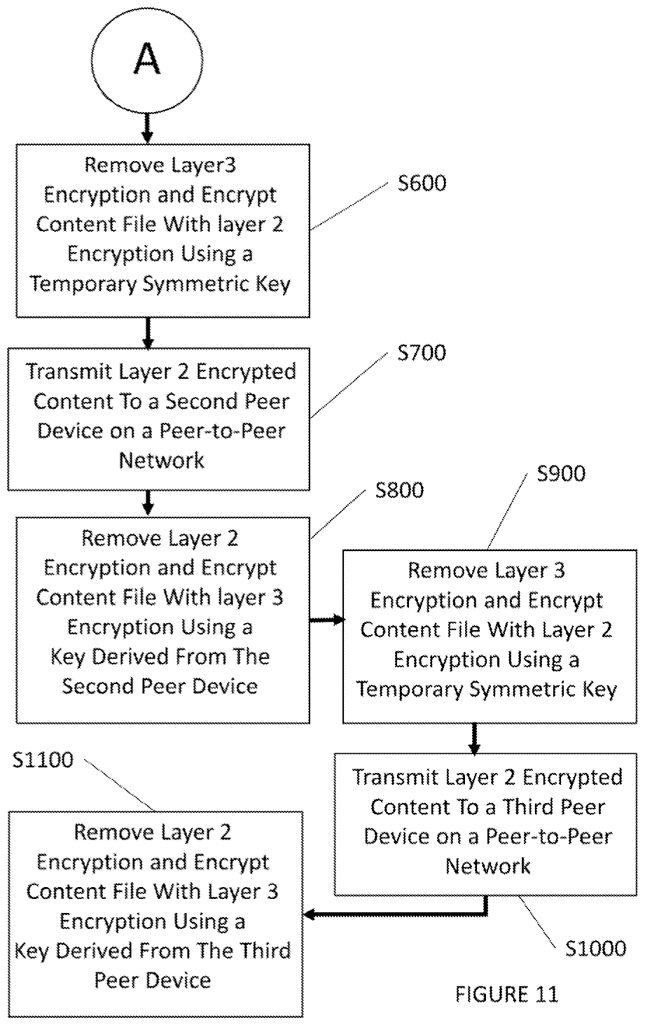

As illustrated in FIG. 11, at step S600, before the content file is transmitted to a second peer computer on the peer-to-peer network, the Layer 3 encryption is removed and the content file is encrypted with Layer 2 encryption using a temporary symmetric key (the temporary symmetric key is a symmetric key exchanged between the two peers).

At step S700, the Layer 2 encrypted content file is transmitted to the second peer computer on the peer-to-peer network. When the second peer computer on the peer-to-peer network receives the Layer 2 encrypted content file, at step S800, the second peer computer removes the Layer 2 encryption and encrypts the content file with Layer 3 encryption using a key derived from the second peer computer.

At step S900, before the content file is transmitted to a third peer computer on the peer-to-peer network, the Layer 3 encryption is removed, and the content file is encrypted with Layer 2 encryption using a temporary symmetric key (the temporary symmetric key is a symmetric key exchanged between the two peers).

At step S1000, the Layer 2 encrypted content file is transmitted to the third peer computer on the peer-to-peer network. When the third peer computer on the peer-to-peer network receives the Layer 2 encrypted content file, at step S1100, the third peer computer removes the Layer 2 encryption and encrypts the content file with Layer 3 encryption using a key derived from the third peer computer.

In summary, each peer on the network is assigned a unique and secret public/private key pair via a crypto-wallet. Content files added to cloud seeders are encrypted with a host associated public key. Content files can only be decrypted digital content file with the associated private key.

If a content file is being transmitted from a seeder computer, the Layer 1 encryption is removed and the content file is encrypted with a symmetric key exchanged between the two peers.

If a content file is being transmitted between two peer computers, the Layer 3 encryption is removed and the content file is encrypted with a symmetric key exchanged between the two peers.

The receiving peer decrypts the content file with the symmetric key and encrypts the content file using a key derived from the peer's private key (Layer 3). This content file can now only be played back with the peer's (purchaser's) private key. The encryption is individualized to the purchaser, which means no other user can consume this content file, even if the user purchased the same piece of content. The user would have their own version of the content file encrypted with a key derived from the user's private key.

In the above described encrypted network, if a user authenticated to a new computer, thus adding a new peer to the network, new content files would need to be downloaded encrypted to the key of the new peer.

Furthermore, with respect to the above described encrypted network, since the final encryption key is secret even from the user, it would require full access to the memory of the system and decompiling the application binaries to find the key. Thus, even though standard encryption tools are used, the content files being transmitted over the above described encrypted network would be extremely difficult to decrypt.

The above described encrypted network requires end users to have unique public/private keys to participate in purchasing access to content files through the above described decentralized distributive system.

By requiring each peer on the network to have a unique public/private key pair, content files can be encrypted uniquely for each peer upon which the content file is received/stored.

In addition, the above-described purchase verification step insures that the requesting peer is authorized to have the content file (or partial content file), thus if a hacker attempted to add a peer to the network to collect content files, the lack of purchase verification would prevent content files from being delivered.

The encryption method described above provides a more secure means for transmitting content files over the internet when using a decentralized distributive system.

Moreover, the encryption method described above makes it harder for a hacker to steal content files being transmitted over the internet using a decentralized distributive system.

In addition, the encryption method described above a more secure means for transmitting content files over the internet when using a decentralized distributive system and conventional (standard) encryption tools.

Furthermore, the encryption method described above makes it harder for a hacker to steal content files being transmitted over the internet using a decentralized distributive system and conventional (standard) encryption tools.

In summary, a method provides a digital content file over a decentralized distribution system using an encrypted peer-to-peer network by (a) uploading a Layer 1 encrypted content file to a host device of the decentralized distribution system; (b) decrypting the Layer 1 encrypted digital content file and encrypting the decrypted digital content file with Layer 3 encryption using a public key of the host device; (c) storing the Layer 3 encrypted digital content file on a seeder device of the decentralized distribution system; (d) exchanging a first temporary symmetric key between the seeder device of the decentralized distribution system and a peer device of the decentralized distribution system; (e) decrypting, at the seeder device, the Layer 3 encrypted digital content file and encrypting the decrypted digital content file with Layer 2 encryption using the first temporary symmetric key; (f) transmitting the Layer 2 encrypted digital content file to the peer device of the decentralized distribution system; (g) decrypting, at the peer device, the Layer 2 encrypted digital content file and encrypting the decrypted digital content file with Layer 3 encryption using a public key of the peer device; (h) storing the Layer 3 encrypted digital content file on the peer device of the decentralized distribution system; (i) exchanging a second temporary symmetric key between the peer device of the decentralized distribution system and a consumer device outside the decentralized distribution system; (j) decrypting, at the peer device, the Layer 3 encrypted digital content file and encrypting the decrypted digital content file with Layer 2 encryption using the second temporary symmetric key; (k) transmitting the Layer 2 encrypted digital content file to the consumer device; and (l) decrypting, at the consumer device, the Layer 2 encrypted digital content file.

A method provides a digital content file over a decentralized distribution system using an encrypted peer-to-peer network by (a) uploading a Layer 1 encrypted content file to a host device of the decentralized distribution system; (b) decrypting the Layer 1 encrypted digital content file and encrypting the decrypted digital content file with Layer 3 encryption using a public key of the host device; (c) storing the Layer 3 encrypted digital content file on a seeder device of the decentralized distribution system; (d) exchanging a first temporary symmetric key between the seeder device of the decentralized distribution system and a first peer device of the decentralized distribution system; (e) decrypting, at the seeder device, the Layer 3 encrypted digital content file and encrypting the decrypted digital content file with Layer 2 encryption using the first temporary symmetric key; (f) transmitting the Layer 2 encrypted digital content file to the first peer device of the decentralized distribution system; (g) decrypting, at the first peer device, the Layer 2 encrypted digital content file and encrypting the decrypted digital content file with Layer 3 encryption using a public key of the first peer device; (h) storing the Layer 3 encrypted digital content file on the first peer device of the decentralized distribution system; (i) exchanging a second temporary symmetric key between the first peer device of the decentralized distribution system and a second peer device of the decentralized distribution system; (j) decrypting, at the first peer device, the Layer 3 encrypted digital content file and encrypting the decrypted digital content file with Layer 2 encryption using the second temporary symmetric key; (k) transmitting the Layer 2 encrypted digital content file to the second peer device; (l) exchanging a third temporary symmetric key between the second peer device of the decentralized distribution system and a consumer device outside the decentralized distribution system; (m) decrypting, at the second peer device, the Layer 3 encrypted digital content file and encrypting the decrypted digital content file with Layer 2 encryption using the third temporary symmetric key; (n) transmitting the Layer 2 encrypted digital content file to the consumer device; and (o) decrypting, at the consumer device, the Layer 2 encrypted digital content file

A system for providing a digital content file over a decentralized distribution system using an encrypted peer-to-peer network includes a host device of the decentralized distribution system; a seeder device of the decentralized distribution system operatively connected to the host device, and a plurality of peer devices of the decentralized distribution system operatively connected to the seeder device; the host device receiving a Layer 1 encrypted content file; the host device decrypting the Layer 1 encrypted digital content file and encrypting the decrypted digital content file with Layer 3 encryption using a public key of the host device; the seeder device receiving the Layer 3 encrypted digital content file and storing thereof; the seeder device and a peer device exchanging a first temporary symmetric key; the seeder device decrypting the Layer 3 encrypted digital content file and encrypting the decrypted digital content file with Layer 2 encryption using the first temporary symmetric key; the seeder device transmitting the Layer 2 encrypted digital content file to the peer device; the peer device decrypting the Layer 2 encrypted digital content file and encrypting the decrypted digital content file with Layer 3 encryption using a public key of the peer device and storing thereof; the peer device and a consumer device exchanging a second temporary symmetric key; the peer device decrypting the Layer 3 encrypted digital content file and encrypting the decrypted digital content file with Layer 2 encryption using the second temporary symmetric key; the peer device transmitting the Layer 2 encrypted digital content file to the consumer device; the consumer device decrypting the Layer 2 encrypted digital content file.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. A method of providing a digital content file over a decentralized distribution system using an encrypted peer-to-peer network, comprising:
(a) uploading a Layer 1 encrypted content file to a host device of the decentralized distribution system;
(b) decrypting the Layer 1 encrypted digital content file and encrypting the decrypted digital content file with Layer 3 encryption using a public key of the host device;
(c) storing the Layer 3 encrypted digital content file on a seeder device of the decentralized distribution system;
(d) exchanging a first temporary symmetric key between the seeder device of the decentralized distribution system and a peer device of the decentralized distribution system;
(e) decrypting, at the seeder device, the Layer 3 encrypted digital content file and encrypting the decrypted digital content file with Layer 2 encryption using the first temporary symmetric key;
(f) transmitting the Layer 2 encrypted digital content file to the peer device of the decentralized distribution system;
(g) decrypting, at the peer device, the Layer 2 encrypted digital content file and encrypting the decrypted digital content file with Layer 3 encryption using a public key of the peer device;
(h) storing the Layer 3 encrypted digital content file on the peer device of the decentralized distribution system;
(i) exchanging a second temporary symmetric key between the peer device of the decentralized distribution system and a consumer device outside the decentralized distribution system;
(j) decrypting, at the peer device, the Layer 3 encrypted digital content file and encrypting the decrypted digital content file with Layer 2 encryption using the second temporary symmetric key;
(k) transmitting the Layer 2 encrypted digital content file to the consumer device; and
(l) decrypting, at the consumer device, the Layer 2 encrypted digital content file.

2. The method as claimed in claim 1, further comprising:
(m) encrypting the decrypted digital content file with Layer 3 encryption using a public key of the consumer device and storing the Layer 3 encrypted digital content file on the consumer device.

3. The method as claimed in claim 1, further comprising:
(m) consuming, at the consumer device, the decrypted digital content file.

4. A method of providing a digital content file over a decentralized distribution system using an encrypted peer-to-peer network, comprising:
(a) uploading a Layer 1 encrypted content file to a host device of the decentralized distribution system;
(b) decrypting the Layer 1 encrypted digital content file and encrypting the decrypted digital content file with Layer 3 encryption using a public key of the host device;
(c) storing the Layer 3 encrypted digital content file on a seeder device of the decentralized distribution system;
(d) exchanging a first temporary symmetric key between the seeder device of the decentralized distribution system and a first peer device of the decentralized distribution system;
(e) decrypting, at the seeder device, the Layer 3 encrypted digital content file and encrypting the decrypted digital content file with Layer 2 encryption using the first temporary symmetric key;
(f) transmitting the Layer 2 encrypted digital content file to the first peer device of the decentralized distribution system;
(g) decrypting, at the first peer device, the Layer 2 encrypted digital content file and encrypting the decrypted digital content file with Layer 3 encryption using a public key of the first peer device;
(h) storing the Layer 3 encrypted digital content file on the first peer device of the decentralized distribution system;
(i) exchanging a second temporary symmetric key between the first peer device of the decentralized distribution system and a second peer device of the decentralized distribution system;
(j) decrypting, at the first peer device, the Layer 3 encrypted digital content file and encrypting the decrypted digital content file with Layer 2 encryption using the second temporary symmetric key;
(k) transmitting the Layer 2 encrypted digital content file to the second peer device;
(l) exchanging a third temporary symmetric key between the second peer device of the decentralized distribution system and a consumer device outside the decentralized distribution system;
(m) decrypting, at the second peer device, the Layer 3 encrypted digital content file and encrypting the decrypted digital content file with Layer 2 encryption using the third temporary symmetric key;
(n) transmitting the Layer 2 encrypted digital content file to the consumer device; and
(o) decrypting, at the consumer device, the Layer 2 encrypted digital content file.

5. The method as claimed in claim 4, further comprising:
(p) encrypting the decrypted digital content file with Layer 3 encryption using a public key of the consumer device and storing the Layer 3 encrypted digital content file on the consumer device.

6. The method as claimed in claim 4, further comprising:
(p) consuming, at the consumer device, the decrypted digital content file.

7. A system for providing a digital content file over a decentralized distribution system using an encrypted peer-to-peer network, comprising:
a host device of the decentralized distribution system;
a seeder device of the decentralized distribution system operatively connected to said host device, and
a plurality of peer devices of the decentralized distribution system operatively connected to said seeder device;
said host device receiving a Layer 1 encrypted content file;
said host device decrypting the Layer 1 encrypted digital content file and encrypting the decrypted digital content file with Layer 3 encryption using a public key of said host device;
said seeder device receiving the Layer 3 encrypted digital content file and storing thereof;
said seeder device and a peer device exchanging a first temporary symmetric key;
said seeder device decrypting the Layer 3 encrypted digital content file and encrypting the decrypted digital content file with Layer 2 encryption using said first temporary symmetric key;
said seeder device transmitting the Layer 2 encrypted digital content file to said peer device;
said peer device decrypting the Layer 2 encrypted digital content file and encrypting the decrypted digital content file with Layer 3 encryption using a public key of said peer device and storing thereof;
said peer device and a consumer device exchanging a second temporary symmetric key;
said peer device decrypting the Layer 3 encrypted digital content file and encrypting the decrypted digital content file with Layer 2 encryption using said second temporary symmetric key;
said peer device transmitting the Layer 2 encrypted digital content file to said consumer device;
said consumer device decrypting the Layer 2 encrypted digital content file.

8. The system as claimed in claim 7, wherein said consumer device encrypts the decrypted digital content file with Layer 3 encryption using a public key of said consumer device and stores thereof.

9. The system as claimed in claim 7, wherein said consumer device consumes the decrypted digital content file.

10. The system as claimed in claim 7, wherein said peer device and a second peer device exchange a third temporary symmetric key;
said peer device decrypting the Layer 3 encrypted digital content file and encrypting the decrypted digital content file with Layer 2 encryption using said third temporary symmetric key;
said peer device transmitting the Layer 2 encrypted digital content file to said second peer device;
said second peer device decrypting the Layer 2 encrypted digital content file and encrypting the decrypted digital content file with Layer 3 encryption using a public key of said second peer device and storing thereof.

11. The system as claimed in claim 7, wherein said second peer device and said consumer device exchanging a fourth temporary symmetric key;
said second peer device decrypting the Layer 3 encrypted digital content file and encrypting the decrypted digital content file with Layer 2 encryption using said fourth temporary symmetric key;
said second peer device transmitting the Layer 2 encrypted digital content file to said consumer device;
said consumer device decrypting the Layer 2 encrypted digital content file.
